(19) United States
(12) Patent Application Publication
(10) Pub. No.: US 2007/0168249 A1
(43) Pub. Date: Jul. 19, 2007

(54) Method of Invisibly Linking Documents

(75) Inventor: Brian Lee Echard, Broad Brook, CT (US)

Correspondence Address: BRIAN ECHARD, 5 HEMLOCK DR., BROAD BROOK, CT, 06016, US

(73) Assignee: Brian Lee Echard, Broad Brook, CT (US)

(21) Appl. No.: 11/306,859

(22) Filed: Jan. 13, 2006

(51) Int. Cl. G06Q 30/00

(52) U.S. Cl. 705/14

(57) ABSTRACT

A method of invisibly linking documents. The invisible link can be created using images or text links. The purpose of the method is to give websites the ability to generate revenue without having to sell visual space and allow advertisers to purchase non-visual citations that will increase the number and quality of incoming links to their document.

### FEDERALLY SPONSORED RESEARCH

Not Applicable

### SEQUENCE LISTING OR PROGRAM

Not Applicable

### BACKGROUND OF THE INVENTION

1. Field of Invention

This application relates to Internet search, particularly the invisible linking of documents.

2. Prior Art

The Internet is a vast interconnected network of computers, servers, and network attached electronic devices that exchange information using internet protocols such as TCP/IP, HTTP, HTTPS, FTP, and POP3. The World Wide Web (WWW) and e-mail are two of the most popular services that use these protocols to exchange data.

The most common use of the WWW is to request information that is stored on server computers. Servers are powerful computers specializing in sending information to remote computers. Businesses and individuals place information on servers most commonly as web pages. Web Pages are documents typically designed using Hypertext Markup Language or HTML. Users view these documents on the WWW using a web browser such as Microsoft Internet Explorer, Firefox, or Netscape.

The servers send information to remote computers when a user sends a request for the information. A user requests access to a server by typing the Uniform Resource Locator or URL into the web browser. A user can also request web pages by following hyperlinks on web pages by clicking on them. The server receives this request and sends the data back to the requesting computer. The browser receives this information and ideally displays it according to the standards created by the World Wide Web Consortium or W3C.

Individuals and businesses want visitors to see the information that they have made available on their web servers. As a result advertisers commonly purchase visual ads that are displayed on websites as visual images and/or text to gain exposure. The purpose of the ads is to get a user to see them and hopefully click on the ad which will take them to the advertiser's website. Advertisements allow webmasters to generate revenue and the advertiser to gain exposure each time the user views and/or clicks the visual ad.

The problem or issue with graphical ads is that they can interfere with the content on the website they are placed on and can lower the quality of the user's experience. As a result webmasters prefer to keep visual ads to a minimum and strategically place them to maintain the user experience. From the webmasters point of view, less graphical ads is better for the users' experience. From the advertisers point of view graphical ads are intended to be seen by the user so the bigger the ad the better the exposure to an extent. A visitor is more likely to see a full banner ad than they are to see a half-banner ad and a visitor won't click an ad they don't see. This can put webmasters at odds with advertisers yet webmasters need advertisers to generate revenue.

A growing number of internet users rely on search engines to find the websites that contain what they are looking for instead of visual ads or word of mouth. As a result advertisers want to be the first result found when searching for relevant terms but this is difficult to achieve. Even if a website has the relevant content and keywords it may not appear as a top search result for several reasons. One reason is that search engines calculate importance by giving some value to the number of incoming links to a website. U.S. Pat. Nos. 6,285,999 and 6,799,176 invented by Lawrence Page explain that documents are rated for importance by a combination of the number and quality of incoming links. The idea is that highly cited documents must be important and thus relevant based on the ranking of citations. As a result a website can gain value by selling non-visual citations or links to advertisers that also benefit from the citation or link.

Objective: A method of invisibly linking documents that allows advertisers to purchase links without having to purchase visual space. It also will allow websites to generate revenue without using visual space on documents.

What are the current options to accomplish this objective?

Option 1: As I mentioned earlier the most common way that is done today is through graphical advertisements even though the reference is really only an indirect benefit. For the reference to work the link should be persistent whereas a typical graphical ad rotates with other sponsors. The only way to create this reference is through the use of hyperlinks ads that do not change over a specified period of time.

Option 2: Some websites allow static graphical or text ads. This still isn't a perfect solution because the ads are visual. The webmaster would still have to pay for the visual ad even though they only want an incoming reference link.

None of today's options satisfy the base requirement. The best solution would be an invisible link or citation that allows a website to pay for a reference without having to pay for the visual aspect of the ad. In that regard this invention is truly unique. The technology used to do this isn't new but it hasn't been combined to create such an innovative solution for linking documents.

### BACKGROUND OF THE INVENTION—OBJECTS AND ADVANTAGES

The object is an invisible citation or link. This is accomplished with a transparent link or by camouflaging the link into the existing content.

Advantage 1: The invisible citation is invisible to visitors because it has no visual indicator that it exists. It can be created several different ways. One method is using a transparent image and a hyperlink. It can also be made using an image map and hot spots to create multiple hyperlinks. A third method is to embed the links within existing text so that it doesn't look like a link. The webmaster can also choose an image that either matches the background of their website or an existing image from the website's content. Regardless of the method the link would be invisible to the user of the website because the link is either transparent or incorporated into the existing content with no visual indicator that it is a link. The link is formatted so that it doesn't have the typical border or colors indicating that it's a link. It's also formatted so the cursor does not change because of the image or link. As a result of all of these attributes it is nearly impossible for the average user to find the invisible citation by looking at the document.

Advantage 2: The invisible citation can take up as little as one pixel per link. This is possible because the image is either broken up into hotspots using an image map or created using a 1 pixel by 1 pixel image. Each pixel will then link to the paying advertiser's website. Even though the citation is nearly invisible it is important that the citation be as small as possible.

Advantage 3: The advertiser is only paying for the incoming hyperlink citation without having to pay for a combined visual ad.

FAQ 1: What is the difference between Invisible Hyperlink Ads and Traditional Graphical Ads?

Size: One Invisible Hyperlink ad takes up as little as 1 pixel versus 28,080 pixels for a standard banner ad.

Specialized: Allows an advertiser to pay for a hyperlink without having to pay for a visual advertisement.

Cost: The Invisible Hyperlink Ad costs less for advertisers because it's 1/28,080 the size of a standard banner ad and because it's a non-visual ad.

User Experience: The difference from traditional ads is that these are made to be invisible to the user. The user will have no visual indicator on the document that these ads exist.

Groundbreaking: Until now there hasn't been a way for advertisers to buy an invisible hyperlink citation or for a webmaster to sell one. The best solution until now has been to purchase visual advertisements.

FAQ 2: Who will use the technology?

Webmasters: The invisible ad allows websites to generate ad revenue without adding graphical ads. Graphical ads are unpopular among website visitors because they often interfere with the content and user experience. The Invisible Hyperlink Ad does not interfere with the content because it's made using existing graphics from the content so the visitors don't notice it.

Advertisers: The invisible ad allows websites to gain references from other websites for less money than a traditional graphical ad. The direct benefit is that their websites could gain a higher ranking from search engines as a result of the increased number of incoming links to their website.

### SUMMARY

The invisible citation or link can be a small transparent image with a link or an image broken up into small hyperlink hot spots using an image map to create a way for webmasters to sell advertisers an invisible incoming hyperlink.

### DETAILED DESCRIPTION—PREFERRED EMBODIMENT

Methods of creating an invisible link:

Method 1—a transparent image, image map, hot spots, and hyperlinks.

Step 1: Create a transparent image such as a GIF of any size from 1px and higher based on the needs of the website that the ad will be placed on.

Step 2: Create hot spots using an image map. The number and size of the hot spots is customizable.

Step 3: Link image to image map

Example of the finished code with comments.

<html>
<head>
<title>Method 1</title>
</head>
<body>
<!-- Ties the image to the imagemap with no border and the cursor will
not change when over the ad -->
<img src=“9.gif” usemap=“#009” border=“0” style=“cursor:default”>
<!-- The name of the image map below -->
<MAP NAME=“009”>
<!-- Each row is an individual hot spot hyperlink. If the link is
accidentally clicked on
it will open a new browser window so it won't interfere with the website
it is located on. -->
<AREA SHAPE=RECT COORDS=“0,0,1,1”
HREF=“http://1.InvisAd.com” target=_blank>
<AREA SHAPE=RECT COORDS=“0,1,1,2”
HREF=“http://2.InvisAd.com” target=_blank>
<AREA SHAPE=RECT COORDS=“0,2,1,3”
HREF=“http://3.InvisAd.com” target=_blank>
<AREA SHAPE=RECT COORDS=“1,0,2,1”
HREF=“http://4.InvisAd.com” target=_blank>
<AREA SHAPE=RECT COORDS=“1,1,2,2”
HREF=“http://5.InvisAd.com” target=_blank>
<AREA SHAPE=RECT COORDS=“1,2,2,3”
HREF=“http://6.InvisAd.com” target=_blank>
<AREA SHAPE=RECT COORDS=“2,0,3,1”
HREF=“http://7.InvisAd.com” target=_blank>
<AREA SHAPE=RECT COORDS=“2,1,3,2”
HREF=“http://8.InvisAd.com” target=_blank>
<AREA SHAPE=RECT COORDS=“2,2,3,3”
HREF=“http://9.InvisAd.com” target=_blank>
<!-- Closing tag for the image map -->
</MAP>
</body>
</html>

Method 2—a small transparent image and a hyperlink.

Step 1: Create a transparent image as small as 1 pixel by 1 pixel.

Step 2: Add code to the document

<html>
<head>
<title>Method 2</title>
</head>
<body>
<a href=“http://www.invisad.com” target=“_blank”
style=“cursor:text;text-decoration:none” border=“0”><img src=“1.gif”
border=“0” style=“cursor:default”></a>
</body>
</html>

Method 3—an image from existing content, an image map, hot spots, and hyperlinks.

Step 1: Select an image from the existing content based on the needs of the website that the ad will be placed on.

Step 2: Create hot spots using an image map.

Step 3: Link image to image map

Example of the finished code with comments.

<html>
<head>
<title>Method 3</title>
</head>
<body>
<!-- Ties the image to the imagemap with no border and the cursor will
not change when over the ad -->
<img src=“logo.gif” usemap=“#009” border=“0” style=“cursor:default”>
<!-- The name of the image map below -->
<MAP NAME=“009”>
<!-- Each row is an individual hot spot hyperlink. If the link is
accidentally clicked on
it will open a new browser window so it won't interfere with the website
it is located on. -->
<AREA SHAPE=RECT COORDS=“0,0,1,1”
HREF=“http://1.InvisAd.com” target=_blank>
<AREA SHAPE=RECT COORDS=“0,1,1,2”
HREF=“http://2.InvisAd.com” target=_blank>
<AREA SHAPE=RECT COORDS=“0,2,1,3”
HREF=“http://3.InvisAd.com” target=_blank>
<AREA SHAPE=RECT COORDS=“1,0,2,1”
HREF=“http://4.InvisAd.com” target=_blank>
<AREA SHAPE=RECT COORDS=“1,1,2,2”
HREF=“http://5.InvisAd.com” target=_blank>
<AREA SHAPE=RECT COORDS=“1,2,2,3”
HREF=“http://6.InvisAd.com” target=_blank>
<AREA SHAPE=RECT COORDS=“2,0,3,1”
HREF=“http://7.InvisAd.com” target=_blank>
<AREA SHAPE=RECT COORDS=“2,1,3,2”
HREF=“http://8.InvisAd.com” target=_blank>
<AREA SHAPE=RECT COORDS=“2,2,3,3”
HREF=“http://9.InvisAd.com” target=_blank>
<!-- Closing tag for the image map -->
</MAP>
</body>
</html>

Method 4—small images hidden into the existing content.

Step 1: Create an image as small as 1 pixel by 1 pixel with the same color as the background or an existing image from the content. In this example the image is white on a white background.

Step 2: Add code to the document over the background or over existing images. In this example the image is on a white background.

<html>
<head>
<title>Method 4</title>
</head>
<body>
<a href=“http://www.invisad.com” target=“_blank”
style=“cursor:text;text-decoration:none” border=“0”><img src=“1.gif”
border=“0”style=“cursor:default”></a>
</body>
</html>

Method 5—a link that is hidden in the existing text content of the document.

Step 1: Insert the link around a letter in the existing text content as shown below.

<html>
<head>
<title>Method 5</title>
</head>
<body>
<p>Method 5&ndash;Method of creating <A
HREF=http://www.invisad.com target=“_blank” style=“cursor:text;text-
decoration:none;color:#000000” border=“0”>a</a> link without a
visual indicator of the link by
hiding a link into the existing text of the document.</p>
</body>
</html>

Method 6—a text link that is the same color as the background or content it is placed with.

Step 1: determine the background or color of the content where the link will be placed. In this case the background is white.

Step 2: Insert the link into the document. In the example below the link would be a white “.” On a white background.

<html>
<head>
<title>Method 6</title>
</head>
<body>
<A HREF=http://www.invisad.com target=“_blank”
style=“cursor:default;text-decoration:none;color:#FFFFFF”
border=“0”>link</A>
</body>
</html>

### Operation

The invisible citation is placed on a website by the webmaster. It is then populated with advertisers' hyperlinks as they pay for the links. Search engine robots will find the links every time they visit websites that the ads are placed on. Users should not notice the ad when visiting the website because there is no visual indicator of the ads existence. If they click on the ad by accident or because they purposely find the ad then the advertiser's website will open in a new browser window so that the user can close the window and resume where they left off as if it were a pop-up ad.

### CONCLUSION, RAMIFICATION, SCOPE

The invisible citation is the best option for webmasters to sell invisible incoming hyperlinks to advertisers because it's non-visual, small, efficient, and specialized.
It's invisible because it's made without any visual indicators of its existence.
It provides the most efficient use of screen space because each link takes up as little as one pixel of screen space.
It provides advertisers will a specialized way of buying incoming hyperlink ads without having to pay for a visual ad. It also provides websites a way of increasing revenue without taking up visual space on their documents.

Although the description above contains many detailed specifications regarding the invisible citation, these should not be misinterpreted as limiting the scope of the invention. It is merely describing the presently preferred embodiments of this invention. For example, the invisible image of choice is currently in the GIF format but there may be a newer format in the future that would improve this method by reducing the file size or offering better resolution. The embodiment of the patent remains the same even if the newer technology is used. The scope of the invention should be determined by the appended claims rather than by the examples given.

Definition List 1

Term: Image Map
Definition: A single graphic image containing more than one hot spot. For example, imagine a graphic of a bowl of fruit. When you click on a banana, the system displays the number of calories in a banana and when you click on an apple, it displays the number of calories in an apple. Image maps are used extensively on the World Wide Web. Each hot spot in a Web image map takes you to a different Web page.

Term: Hyperlink
Definition: An element in an electronic document that links to another place in the same document or to an entirely different document. Typically, you click on the hyperlink to follow the link. Hyperlinks are the most essential ingredient of all hypertext systems, including the World Wide Web.

Term: Hot spots
Definition: An area of a graphics object, or a section of text, that activates a function when selected. Hot spots are particularly common in multimedia applications, where selecting a hot spot can make the application display a picture, run a video, or open a new window of information.

Term: URL
Definition: Abbreviation of Uniform Resource Locator, the global address of documents and other resources on the World Wide Web.

Term: HTML
Definition: Short for HyperText Markup Language, the authoring language used to create documents on the World Wide Web. HTML is similar to SGML, although it is not a strict subset.

Term: Cascading Style Sheets
Definition: Short for Cascading Style Sheets, a new feature being added to HTML that gives both Web site developers and users more control over how pages are displayed. With CSS, designers and users can create style sheets that define how different elements, such as headers and links, appear. These style sheets can then be applied to any Web page.

Term: Graphics File**
Definition: General term used for a computer file containing a picture: photographic image; illustration; etc.

Term: Reference
Definition: * All definitions in the list were obtained from Webopedia.com on 12-30-05 (http://www.webopedia.com) unless otherwise specified. ** definition from (www.copying.co.uk/glossary.html)

What is claimed is:

1. A method of invisibly linking documents, comprising a graphics file, hypertext markup language, and at least one uniform resource locator.

2. The method of claim 1, wherein said html includes cascading style sheets.

3. The method of claim 1, wherein said html includes a style tag.

4. The method of claim 1, wherein said graphics file is transparent.

5. The method of claim 1, wherein said html includes an image map and at least one hot spot.

6. A method of invisibly linking documents, comprising text, hypertext markup language, and at least one uniform resource locator.

7. The method of claim 6, wherein said html includes a style tag.

8. The method of claim 6, wherein said html includes cascading style sheets.

9. The method of claim 6, wherein said text is the same color as the background or content thereby making said link invisible.
